(19) United States
(12) Patent Application Publication
(10) Pub. No.: US 2026/0360339 A1
(43) Pub. Date: Nov. 12, 2026

(54) INFORMATION PROCESSING METHOD

(71) Applicant: Yamaha Corporation, Hamamatsu (JP)

(72) Inventor: Masahiro SUZUKI, Yokohama (JP)

(21) Appl. No.: 19/666,837

(22) Filed: May 4, 2026

Related U.S. Application Data
(63) Continuation of application No. PCT/JP2024/038108, filed on Oct. 25, 2024.

(30) Foreign Application Priority Data
Nov. 9, 2023 (JP) 2023-191467

(51) Int. Cl. G10H 1/00

(52) U.S. Cl. CPC G10H 1/0025; G10H 2210/005

(57) ABSTRACT

An information processing method which is realized by a computer system includes acquiring first performance information representing a first part corresponding to one or more musical instruments in a musical piece, and generating second performance information representing a second part corresponding to a musical instrument different from the one or more musical instruments in the musical piece, by processing control data containing the first performance information using a generative model trained through machine learning.

### CROSS-REFERENCE TO RELATED APPLICATIONS

This application is a continuation application of International Application No. PCT/JP2024/038108, filed on Oct. 25, 2024, which claims priority to Japanese Patent Application No. 2023-191467 filed in Japan on Nov. 9, 2023. The entire disclosures of International Application No. PCT/JP2024/038108 and Japanese Patent Application No. 2023-191467are hereby incorporated herein by reference.

### BACKGROUND

### Technical Field

The present disclosure generally relates to a technique for generating information representing a musical piece.

### Background Information

Techniques for executing various processes related to musical pieces including a plurality of parts have been proposed in the prior art. For example, Japanese Laid-Open Patent Application No. 2019-159146 discloses a technique for generating, through machine learning that utilizes features that affect performances of musical instruments, a trained model that selects a part to be played by a specific musical instrument from among a plurality of parts contained in music data.

### SUMMARY

In a situation in which a part of a musical piece corresponding to a specific musical instrument has been produced, producing the other parts of the musical piece requires specialized knowledge of music and considerable effort of the producer. In consideration of such circumstances, an object of one aspect of the present disclosure is to reduce the burden of producing parts of a musical piece other than existing parts.

In order to solve the problem described above, an information processing method according to one aspect of the present disclosure includes acquiring first performance information representing a first part corresponding to one or more musical instruments in a musical piece, and generating second performance information representing a second part corresponding to a musical instrument different from the one or more musical instruments in the musical piece, by processing control data containing the first performance information using a generative model trained through machine learning.

An information processing system according to one aspect of the present disclosure includes an electronic controller including at least one processor, and the electronic controller is configured to acquire first performance information representing a first part corresponding to one or more instruments in a musical piece, and generate second performance information representing a second part corresponding to a musical instrument different from the one or more musical instruments in the musical piece, by processing control data containing the first performance information using a generative model trained through machine learning.

A non-transitory computer-readable medium storing a program according to one aspect of the present disclosure causes a computer system to execute a process including acquiring first performance information representing a first part corresponding to one or more instruments in a musical piece, and generating second performance information representing a second part corresponding to a musical instrument different from the one or more musical instruments in the musical piece by processing control data containing the first performance information using a generative model trained through machine learning.

### BRIEF DESCRIPTION OF THE DRAWINGS

FIG. 1 is a block diagram illustrating a configuration of an information processing system according to a first embodiment.

FIG. 2 is an explanatory diagram relating to an arrangement of a target musical piece by an information processing system.

FIG. 3 is a block diagram illustrating a functional configuration of the information processing system.

FIG. 4 is a schematic diagram of performance information.

FIG. 5 is an explanatory diagram of tokens constituting performance information.

FIG. 6 is a schematic diagram of control data.

FIG. 7 is a schematic diagram of performance information generated from control data.

FIG. 8 is a flowchart of an arrangement process.

FIG. 9 is a block diagram illustrating a configuration of a machine learning system according to a second embodiment.

FIG. 10 is a block diagram illustrating a functional configuration of the machine learning system.

FIG. 11 is a flowchart of a training data generation process.

FIG. 12 is a flowchart of the training process.

FIG. 13 is an explanatory diagram relating to an arrangement of a target musical piece according to a third embodiment.

FIG. 14 is a block diagram illustrating a functional configuration of an information processing system according to a third embodiment.

FIG. 15 is a block diagram illustrating a functional configuration of an information processing system according to a fourth embodiment.

FIG. 16 is an explanatory diagram relating to arranging a target musical piece according to a modified example.

FIG. 17 is a block diagram illustrating a functional configuration of an information processing system according to a modified example.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

### A: First Embodiment

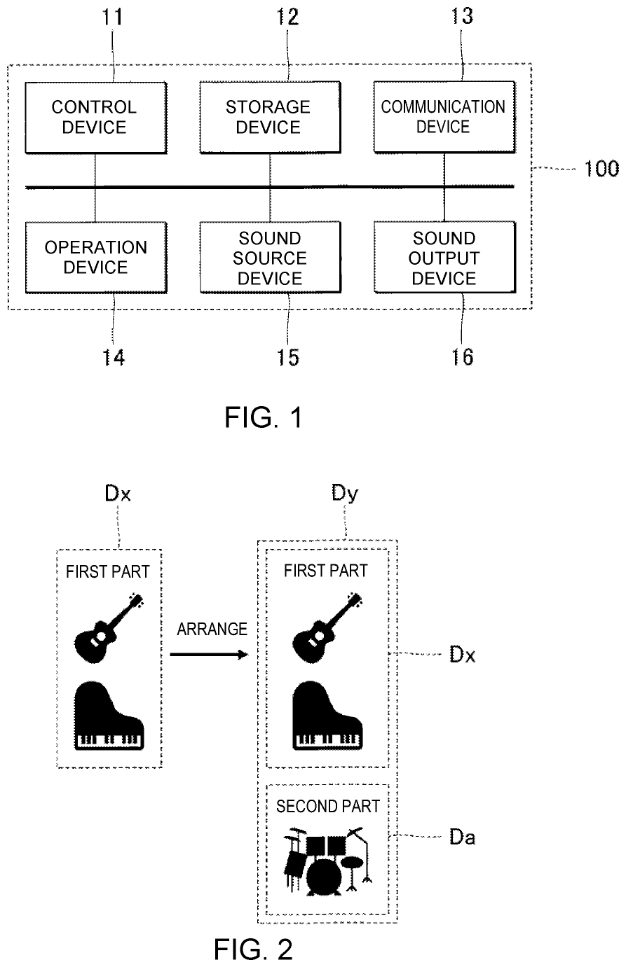

FIG. 1 is a block diagram illustrating a configuration of an information processing system 100 according to a first embodiment. The information processing system 100 is a computer system that arranges an existing musical piece (hereinafter referred to as “target musical piece”) and is realized by an information device such as a smartphone, a tablet terminal, or a personal computer.

FIG. 2 is an explanatory diagram relating to an overview of a process carried out by the information processing system 100. The information processing system 100 generates music data Dy from music data Dx. The music data Dx are time-series data representing a plurality of first parts that constitute a target musical piece. Specifically, the music data Dx represent a time series of notes that constitute each of the plurality of first parts. Each of the plurality of first parts is an existing performance part corresponding to a different type of instrument (musical instrument). A “performance part” is a part (voice) that constitutes a musical piece, meaning, for example, a group of one or more performers (or a group of one or more instruments) that play the same notes. For example, performance parts are distinguished for each musical instrument, for each range, or for each musical role (e.g., main melody, sub-melody).

The music data Dy are time-series data representing a target musical piece in which a new second part has been added to the plurality of first parts. The second part is a performance part corresponding to a type of instrument different from those of the plurality of first parts, and is played in parallel (simultaneously) with the plurality of first parts to constitute the target musical piece. Accordingly, the second part harmonizes musically with the plurality of first parts. As described above, the information processing system 100 arranges an existing target musical piece including a plurality of first parts into a target musical piece to which a new second part has been added.

The music data Dy represent a time series of notes constituting each of the first and second parts of the target musical piece. Specifically, the music data Dy include existing music data Dx representing the plurality of first parts and new music data Da representing the second part. That is, the information processing system 100 generates the music data Da of the second part from the existing music data Dx. The music data Da represent a time series of notes constituting the second part.

The music data Dx and the music data Dy specify, for each of a plurality of performance parts, the pitch and pronunciation period for each note constituting the performance part. Pitch is one of a plurality of discretely set scale tones (for example, note number). Pronunciation period is specified by, for example, the starting point and duration (or ending point) of a note. The music data Dx and the music data Dy are music files conforming to the MIDI (Musical Instrument Digital Interface) standard, for example. The music data Dx are an example of “first music data,” and the music data Da or the music data Dy are an example of “second music data.”

As shown in FIG. 1, the information processing system 100 includes a control device 11, a storage device 12, a communication device 13, an operation device 14, a sound source device 15, and a sound output device 16. The information processing system 100 can be realized as a single device, or as a plurality of devices which are separately configured.

The control device 11 is an electronic controller that includes one or a plurality of processors that control each element of the information processing system 100. For example, the control device 11 includes one or more types of processors, such as a CPU (Central Processing Unit), a GPU (Graphics Processing Unit), an SPU (Sound Processing Unit), a DSP (Digital Signal Processor), an FPGA (Field Programmable Gate Array), an ASIC (Application Specific Integrated Circuit), and the like. Here, the term “electronic controller” as used herein refers to hardware, and does not include a human. The communication device 13 communicates with an external device via a communication network (via wired or wireless connection), such as the Internet.

The storage device 12 includes one or more memory units (one or more computer memories) for storing a program that is executed by the control device 11 and various data that are used by the control device 11. For example, the storage device 12 stores the music data Dx of a target musical piece. The storage device 12 is a known storage medium, such as a magnetic storage medium or a semiconductor storage medium. The storage device 12 can include a combination of a plurality of types of storage media. A portable storage medium that is attached to/detached from the information processing system 100, or a storage medium (for example, cloud storage) that the control device 11 can read from or write to via a communication network can also be used as the storage device 12. The storage device 12 is one example of a non-transitory storage medium.

The operation device 14 is an input device (user operable input) that receives instructions from a user. For example, the operation device 14 is an operator operated by the user, or a touch panel that detects touch by the user. A user can operate the operation device 14 to specify the type of musical instrument corresponding to the second part. For example, the user operates the operation device 14 to select the desired type of instrument from a plurality of candidates prepared in advance. Note that the operation device 14 that is separate from the information processing system 100 can be connected to the information processing system 100 wirelessly or by wire.

The sound source device (sound generator) 15 generates an audio signal representing waveforms of musical sounds specified by the music data Dx or the music data Dy. Note that the control device 11 can execute a program to realize the function of the sound source device 15.

The sound output device 16 reproduces sound waves under the control of the control device 11. The sound output device 16 is an output device such as a loudspeaker (speaker) or headphones. Specifically, the sound output device 16 reproduces musical sounds of the target musical piece represented by the audio signal generated by the sound source device 15. Note that the sound source device 15 or the sound output device 16 that is separate from the information processing system 100 can be connected to the information processing system 100 wirelessly or by wire.

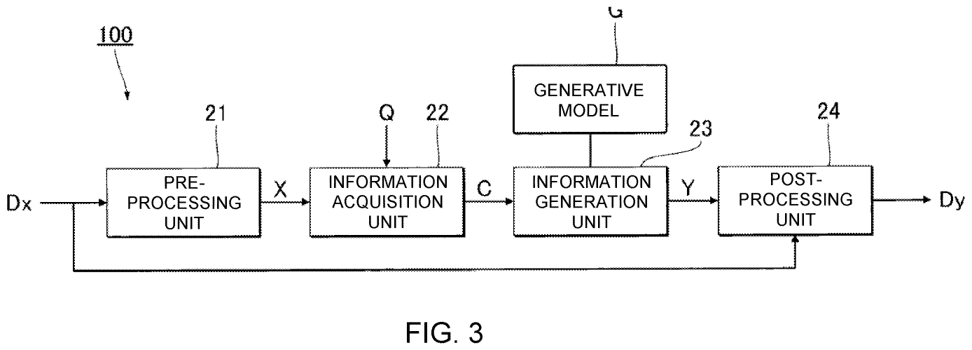

FIG. 3 is a block diagram illustrating a functional configuration of the information processing device 100. The control device 11 executes a program stored in the storage device 12 to realize(execute) a plurality of functions (pre-processing unit 21, information acquisition unit 22, information generation unit 23, post-processing unit 24) for generating the music data Dy of the target musical piece that has been arranged, from the music data Dx of the existing target musical piece.

The pre-processing unit 21 generates performance information X from the music data Dx. The performance information X is time-series data representing a plurality of first parts of a target musical piece. The performance information X can also be expressed as intermediate or alternative data in a format different from that of the music data Dx. The performance information X is one example of “first performance information.”

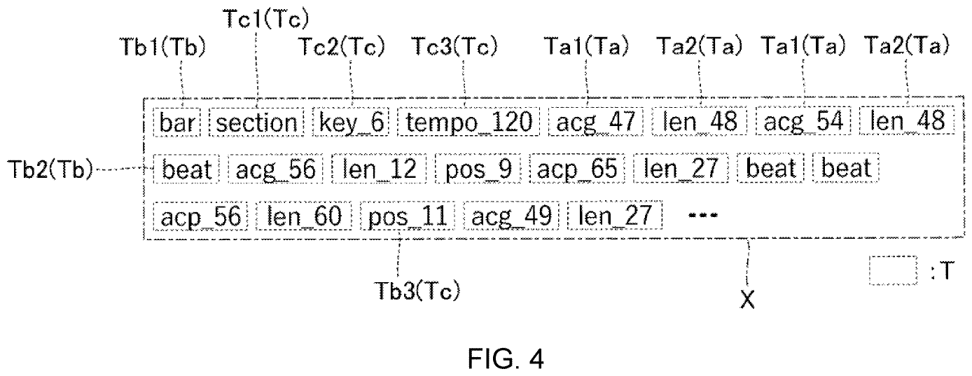

FIG. 4 is a schematic diagram of the performance information X. The performance information X is a time series of a plurality of tokens T representing each of the first parts of the target musical piece. A token T is a unit that constitutes the performance information X. The performance information X is described, for example, by a series of character strings. In FIG. 4, the performance information X is shown as character strings spanning several rows. The tokens T are separated by blank spaces (for example, half-width spaces).

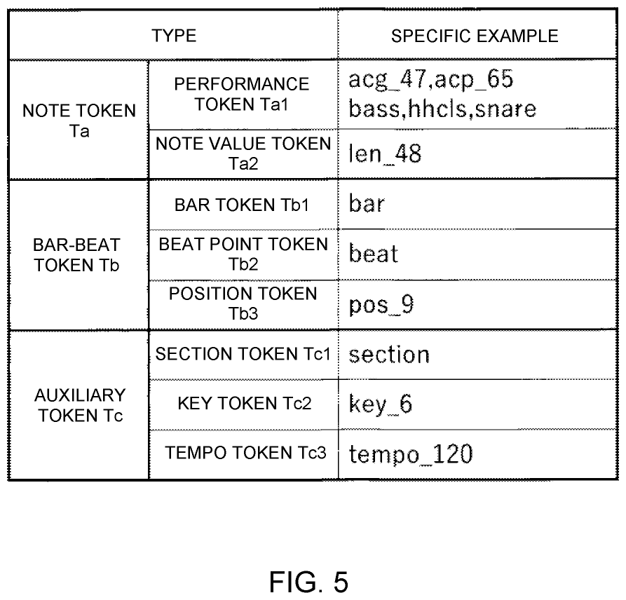

FIG. 5 is an explanatory diagram of tokens T. A plurality of tokens T constituting the performance information X includes a note token Ta, a bar-beat token Tb, and an auxiliary token Tc.

The note token Ta is a token T that expresses musical notes of a target musical piece. Specifically, the note token Ta is distinguished into a performance token Ta1 and a note value token Ta2. The performance token Ta1 specifies the type of musical instrument used to play a musical note and the pitch (for example, note number) of the musical note. For example, a performance token Ta1 labeled “acg_47” refers to a musical note with a pitch of 47 that should be played on an acoustic guitar (acg: acoustic guitar). In addition, a performance token Ta1 labeled “acp_65” refers to a musical note with a pitch of 65 that should be played on an acoustic piano (acp: acoustic piano). The performance token Ta1 can also be expressed as identification information that specifies the type of musical instrument.

Note the value token Ta2 specifies a note value (duration) of a musical note. For example, a note value token Ta2 denoted as “len_L” (L is a natural number) refers to a length of time corresponding to L units of time. A unit time is a length of time corresponding to the beat interval of a target musical piece. Specifically, a unit time is a length of time corresponding to 1/12 of a beat of the target musical piece, for example. One musical note for which a musical instrument, a pitch, and a note value are specified is expressed by a combination of the performance token Ta1 and the note value token Ta2.

The bar-beat token Tb is a token T that expresses the bar-beat of a target musical piece. Specifically, a particular point in time within the target musical piece is expressed by the bar-beat token Tb. Specifically, the bar-beat token Tb is distinguished into a bar tokens Tb1 (bar), a beat point tokens Tb2 (beat), and a position token Tb3 (pos). The bar-beat token Tb that represents a particular point in time in a target musical piece is arranged at a position corresponding to the particular point in time within a time series of tokens T in the performance information X.

The bar token Tb1 is a token T that represents bar lines of a target musical piece (that is, the first beat of each bar). The beat point token Tb2 is a token T that represents each beat point of the target musical piece. The position token Tb3 is a token T that represents a particular point in time in the target musical piece. For example, the position token Tb3 denoted as “pos_K” (K=1 to 11) refers to a point in time when time corresponding to K units of time has elapsed since the bar line (bar token Tb1) or the beat point (beat point token Tb2) immediately preceding the position token Tb3.

The position token Tb3 is used to express the position of a musical note, for example. Specifically, the position of one musical note is expressed by a position token Tb3 placed immediately before a note token Ta (performance token Ta1 and note value token Ta2) representing the musical note. For example, a notation of “pos_9 acp_65 len_27” in the performance information X means that a musical note having a pitch of 65 and a note value of 27, which is played by an acoustic piano (acp), starts at a point in time when nine units of time have elapsed from the immediately preceding beat point (pos_9). Note that in a case where the starting point of a musical note coincides with a bar line (bar token Tb1) or a beat point (beat point token Tb2), the position token Tb3 is omitted. As illustrated above, conditions (pitch, note value, and position) for pronouncing one musical note are specified by the performance token Ta1, the note value token Ta2, and the position token Tb3.

The auxiliary token Tc is a token T that represents various information relating to the performance of the target musical piece. Specifically, the auxiliary token Tc is distinguished into a section token Tc1 (section), a key token Tc2 (key), and a tempo token Tc3 (tempo). The section token Tc1 is a token T that represents the starting point of each structural section of a target musical piece. Each structural section is a section of a target musical piece divided along a time axis in accordance with musical meanings. For example, sections such as intro, verse, bridge, chorus, and outro are examples of structural sections. The section token Tc1 is arranged in the performance information X at one or more positions corresponding to the one or more starting points of the one or more structural sections in the target musical piece.

The key token Tc2 is a token T representing the key of a target musical piece. A numerical value specified by the key token Tc2 is a number for identifying the key. The key token Tc2 is arranged in the performance information X at one or positions corresponding to one or more point in time at which the key changes in the target musical piece. The tempo tokens Tc3 is a token T that represents the tempo of a target musical piece. A numerical value specified by the tempo token Tc3 represents the tempo (BPM: Beats Per Minute). The tempo token Tc3 is arranged at one or more positions in the performance information X corresponding to one or more points in time at which the tempo changes in the target musical piece.

Specific examples of tokens T constituting the performance information X are described above. The pre-processing unit 21 in FIG. 3 converts the music data Dx to the performance information X following the rules illustrated above. According to the first embodiment, widely available existing music data Dx can be used to generate the music data Dy (performance information Y described further below).

The information acquisition unit 22 acquires the performance information X. The information acquisition unit 22 of the first embodiment generates control data C containing the performance information X and instrument information Q. The instrument information Q is information specifying the type of musical instrument corresponding to the second part. Specifically, the type of musical instrument specified by a user through an operation on the operation device 14 is specified by the instrument information Q.

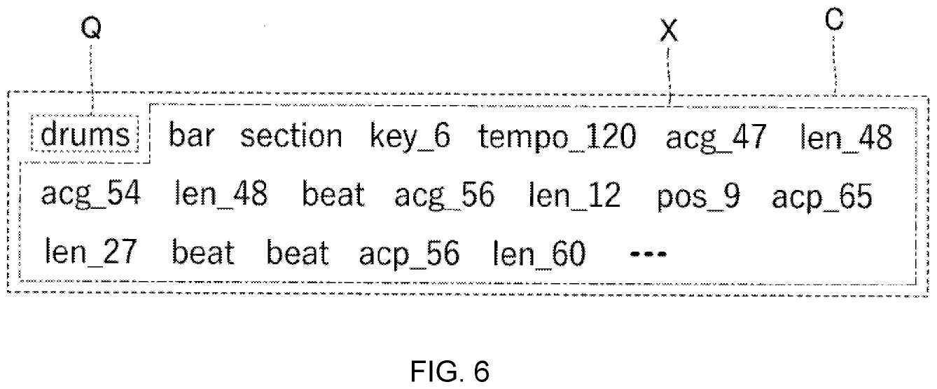

FIG. 6 is a schematic diagram of the control data C. The information acquisition unit 22 generates the control data C by appending the instrument information Q to the beginning of the performance information X. The instrument information Q is appended to the performance information X as a single token T, for example. In the following description, as shown in FIG. 6, a case is assumed in which a drum set (drums) including a plurality of types of percussion instruments is specified as the musical instrument of the second part. The instrument information Q can be appended to any position in the performance information X.

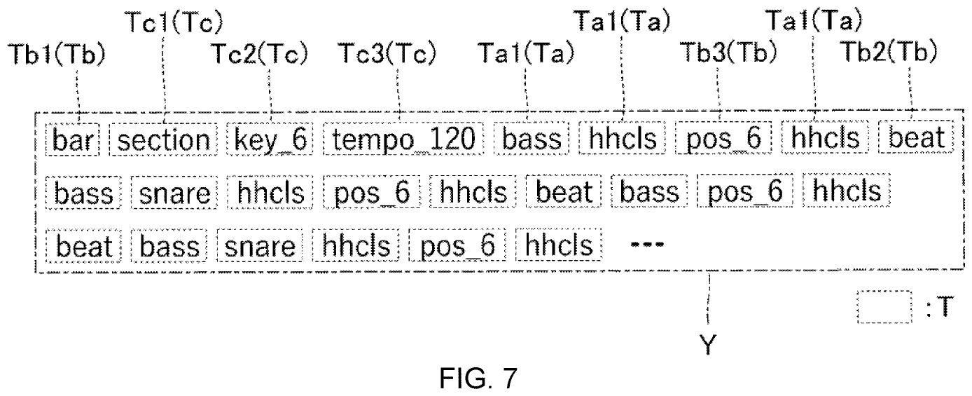

The information generation unit 23 of FIG. 3 generates performance information Y from the control data C. The performance information Y is time-series data representing the second part of the target musical piece after arrangement. FIG. 7 is a schematic diagram of the performance information Y. The performance information Y is a time series of a plurality of tokens T representing the second part of the target musical piece. The performance information Y is described, for example, by a series of character strings, in the same manner as the performance information X. The performance information Y is one example of “second performance information.”

The type and meaning of each token T constituting the performance information Y are the same as those of each token T of the performance information X, described above with reference to FIG. 5. That is, the plurality of tokens T constituting the performance information Y include the note tokens Ta (Ta1, Ta2), the bar-beat tokens Tb (Tb1, Tb2, Tb3), and the auxiliary tokens Tc (Tc1, Tc2, Tc3), in the same manner as the example shown in FIG. 5.

In the first embodiment, as described above, a case is assumed in which a drum set including a plurality of types of percussion instruments is specified as the musical instrument of the second part. The concepts of pitch and note value are not applicable to the performance sounds of the drum set. Accordingly, in the performance information Y illustrated in FIG. 7, the performance tokens Ta1 do not include specification of pitch, and note value tokens Ta2 are not used.

In addition, the performance token Ta1 of a drum set specifies the type of each percussion instrument constituting the drum set. For example, a performance token Ta1 labeled “bass” means a performance of the bass drum, a performance token Ta1 labeled “hhcls” means a performance of the hi-hat, and a performance token Ta1 labeled “snare” means a performance of the snare drum. In a case where an instrument other than a drum set is specified for the second part, as illustrated in FIG. 5, one musical note is expressed by a combination of the performance token Ta1 and the note value token Ta2.

A trained generative model G is used for the generation of the performance information Y by the information generation unit 23. The generative model G is a statistical model that has learned, in advance, the relationship between the control data C and the performance information Y through machine learning. The information generation unit 23 processes the control data C using the trained generative model G to generate the performance information Y.

The generative model G is realized by a combination of a program that causes the control device 11 to execute computation for generating the performance information Y from the control data C, and a plurality of variables (for example, bias and weighted value) that are applied to the computation. Each numerical value of the plurality of variables is set in advance by machine learning.

For example, a transformer, which is an encoder-decoder model including a self-attention mechanism (specifically, a multi-head attention mechanism) is used as the generative model G. A transformer is disclosed, for example, in Ashish Vaswani, Noam Shazeer, Niki Parmar, Jakob Uszkoreit, Llion Jones, Aidan N. Gomez, Lukasz Kaiser, Illia Polosukhin, “Attention Is All You Need”, 31st Conference on Neural Information Processing Systems (NIPS 2017). In addition, MEGA (Moving Average Equipped Gated Attention) can be employed as the generative model G. MEGA is disclosed in Ma, C. Zhou, X. Kong, J. He, L. Gui, G. Neubig, J. May, and L. ZettLemoyer. “Mega: moving average equipped gated attention”, arXiv:2209.10655, 2022.

The format of the performance information X and the performance information Y, each of which includes a time series of a plurality of tokens T, is a format suitable for processing by the generative model G. As described above, according to the first embodiment, the generative model G that is suitable for the processing of a time series of a plurality of tokens T can be used to generate an effective second part that is musically consistent with the first part.

The post-processing unit 24 of FIG. 3 generates music data Dy from the performance information Y. Specifically, the post-processing unit 24 generates the music data Da of the second part from the performance information Y following the rules described above with reference to FIG. 5, and generates the music data Dy by integrating the pre-arrangement music data Dx and the music data Da of the second part. As described above, since the music data Dy are generated from the performance information Y, musical sounds of the second part can be generated by the existing sound source device 15 that is capable of processing the music data Dy.

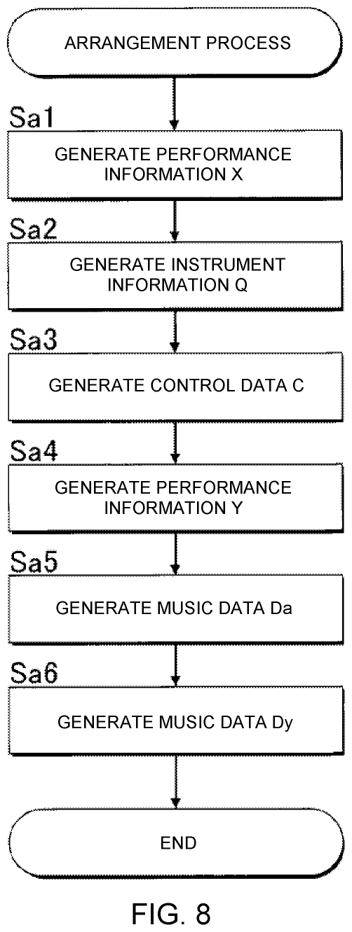

FIG. 8 is a flowchart of a process (hereinafter referred to as “arrangement process”) by which the control device 11 generates the music data Dy from the music data Dx. For example, the arrangement process is started in response to a user's operation on the operation device 14.

In response to the arrangement process starting, the control device 11 (pre-processing unit 21) generates the performance information X from the music data Dx (Sa1). The control device 11 (information acquisition unit 22) generates instrument information Q that specifies the type of musical instrument of the second part (Sa2). The control device 11 (information acquisition unit 22) acquires the performance information X and generates control data C containing the instrument information Q and the performance information X (Sa3).

The control device 11 (information generation unit 23) processes the control data C using the generative model G to generate performance information Y (Sa4). The control device 11 (post-processing unit 24) generates the music data Da of the second part from the performance information Y (Sa5). The control device 11 (post-processing unit 24) generating the music data Dy of the post-arrangement target musical piece by integrating the music data Dx and the music data Da (Sa6).

As described above, in the first embodiment, the performance information Y of the second part corresponding to a musical instrument different from the musical instrument of the first part is generated from the performance information X representing the existing first parts of the target musical piece. Accordingly, it is possible to reduce the burden on a user that produces a second part other than the existing first parts for the target musical piece. That is, according to the first embodiment, it is possible to provide, to the user, a unique customer experience of being able to obtain a new second part that corresponds to the existing first parts.

In particular, in the first embodiment, it is possible to generate the performance information Y for a second part corresponding to the type of musical instrument specified by the instrument information Q. Since the instrument information Q specifies the musical instrument selected by a user, it is possible to generate a second part that aligns with the user's intentions or preferences. In addition, by changing the type of musical instrument specified by the instrument information Q, it is possible to generate second parts of a variety of instruments using a single generative model G.

### B: Second Embodiment

The second embodiment will be described. In each of the embodiments illustrated below, elements that have the same functions as those in first embodiment have been assigned the same reference symbols used to describe the first embodiment and detailed descriptions thereof have been appropriately omitted.

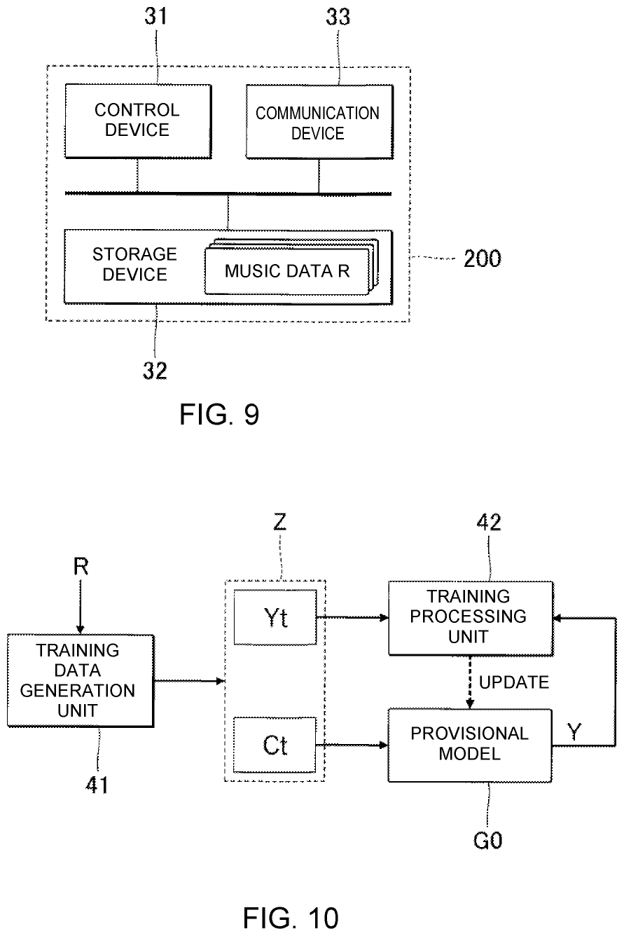

FIG. 9 is a block diagram illustrating a configuration of a machine learning system 200 according to a second embodiment. The machine learning system 200 is a computer system that constructs, through machine learning, the above-mentioned generative model G used by the information processing system 100. The machine learning system 200 includes a control device 31, a storage device 32, and a communication device 33. The machine learning system 200 can be realized as a single device, or as a plurality of devices which are separately configured.

The control device 31 is an electronic controller that includes one or a plurality of processors that control each element of the machine learning system 200. For example, the control device 31 is one or more types of processors, such as a CPU, an SPU, a DSP, an FPGA, an ASIC, and the like.

The communication device 33 communicates with an external device via a communication network (via wired or wireless connection), such as the Internet. For example, the communication device 33 communicates with the information processing system 100. The generative model G constructed by the machine learning system 200 is provided to the information processing system 100 via the communication device 33.

The storage device 32 includes one or more memory units (one or more computer memories) for storing a program that is executed by the control device 31 and various data that are used by the control device 31. The storage device 32 is a known storage medium, such as a magnetic storage medium or a semiconductor storage medium. The storage device 32 can include a combination of a plurality of types of storage media. A portable storage medium that is attached to/detached from the information processing system 100, or a storage medium (for example, cloud storage) that the control device 31 can read from or write to via a communication network can also be used as the storage device 32.

The storage device 32 stores a plurality of pieces of music data R that are used for the machine learning of the generative model G. Each of the plurality of pieces of music data R is time-series data representing a musical piece for machine learning (hereinafter referred to as “reference musical piece”). Each reference musical piece includes H (where H is a natural number greater than or equal to two) performance parts. The music data R represent a time series of notes for each of the H performance parts. In addition, the music data R specify the type of musical instrument for each of the H performance parts. The music data R are music files conforming to the MIDI (Musical Instrument Digital Interface) standard, for example. For example, a large amount of karaoke data produced in the past can be used as the music data R. Accordingly, a large amount of music data R can be easily prepared. The number H of the performance parts of the reference musical piece is different for each reference musical piece.

FIG. 10 is a block diagram illustrating a functional configuration of the machine learning system 200. The control device 31 executes a program that is stored in the storage device 32 to realize a plurality of functions (training data generation unit 41, training processing unit 42) for constructing the generative model G.

The training data generation unit 41 generates a plurality of pieces of training data Z used for the machine learning of the generative model G. Each of the plurality of pieces of training data Z includes a combination of control data Ct for training, and performance information Yt for training. The control data Ct are data in the same format as the above-mentioned control data C. The performance information Yt is data in the same format as the above-mentioned performance information Y. The training data generation unit 41 generates a plurality of pieces of training data Z from a plurality of pieces of music data R stored in the storage device 32. The training processing unit 42 constructs a generative model G through machine learning using the plurality of pieces of training data Z.

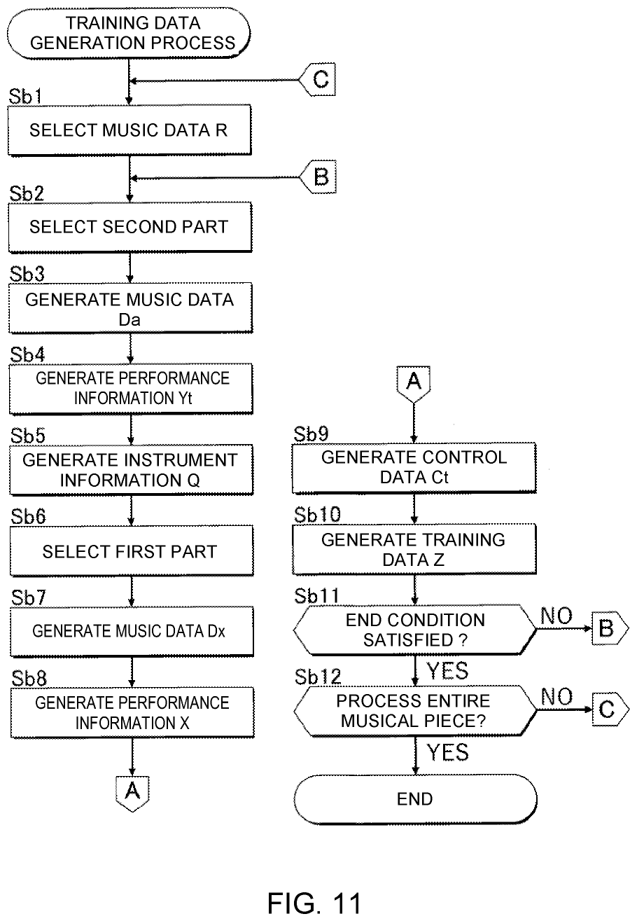

FIG. 11 is a flowchart of a process (hereinafter referred to as “training data generation process”) by which the control device 31 (training data generation unit 41) generates the plurality of pieces of training data Z. For example, the training data generation process is started, triggered by an instruction from an administrator of the machine learning system 200. In response to the training data generation process starting, the control device 31 selects any one of the plurality of pieces of music data R (hereinafter referred to as “selected music data R”) stored in the storage device 32 (Sb1).

The control device 31 selects, as the second part, any one of the H performance parts of the reference musical piece represented by the selected music data R (Sb2), and generates the music data Da of the second part from the selected music data R (Sb3). For example, the portion of the selected music data R corresponding to the second part is extracted as the music data Da. The control device 31 generates the performance information Yt from the music data Da of the second part (Sb4). The process of generating the performance information Yt from the music data Da is the same as the process by which the pre-processing unit 21 generates the performance information X from the music data Dx. The control device 31 generates instrument information Q that represents the type of musical instrument specified by the selected music data R for the second part (Sb5).

The control device 31 selects a plurality of first parts from (H-1) performance parts obtained by excluding the second part from the H performance parts of the reference musical piece represented by the selected music data R (Sb6). For example, (H-1) or fewer first parts are randomly selected from (H-1) performance parts. All possible combinations of selecting a prescribed number of first parts from (H-1) performance parts can be adopted in order. The control device 31 generates, from the selected music data R, music data Dx representing a plurality of first parts (Sb7). For example, portions of the selected music data R corresponding to the plurality of first parts are extracted as the music data Dx. The control device 31 generates the performance information X from the music data Dx (Sb8). The generation of the performance information X is the same as the process by which the pre-processing unit 21 generates the performance information X from the music data Dx.

The control device 31 generates the control data Ct for training containing the performance information X corresponding to the plurality of first parts and the instrument information Q that specifies the musical instrument of the second part (Sb9). Then, the control device 31 associates the control data Ct with the performance information Yt to generate training data Z, and stores the training data Z in the storage device 32 (Sb10).

The control device 31 determines whether a prescribed end condition has been met (Sb11). The end condition is, for example, the number of performance parts selected as the second part from among the H performance parts of the reference musical piece reaching a prescribed value.

Upon determining that the end condition is not satisfied (Sb11: NO), the control device 31 causes the process to proceed to Step Sb2. That is, the control device 31 selects, as the second part, an unselected performance part from the H performance parts of the reference musical piece represented by the selected music data R (Sb2). As described above, generation of the performance information Yt (Sb2 to Sb4), generation of the instrument information Q (Sb5), generation of the control data Ct (Sb6 to Sb9), and generation of the training data Z (Sb10) are repeated until the end condition is satisfied (Sb11: YES). That is, a plurality of pieces of training data Z, each with a different type of instrument in the second part, are generated from the music data R of one reference musical piece.

Upon determining that the end condition is satisfied (Sb11: YES), the control device 31 determines whether the aforementioned process (Sb2 to Sb10) has been executed for all the music data R stored in the storage device 32 (Sb12). In a case where there are unprocessed music data R (Sb12: NO), the control device 31 causes the process to proceed to step Sb1. That is, the control device 31 selects a piece of unprocessed music data R as the new selected music data R (Sb1). As described above, generation of a plurality of pieces of training data Z (Sb2 to Sb10) is repeated for each of the plurality of pieces of music data R. On the other hand, upon determining that all of the music data R have been processed (Sb12: YES), the control device 31 ends the training data generation process.

Meanwhile, in a configuration in which the performance information X and the performance information Yt are prepared separately in the process of generating training data Z, it is necessary to recognize and manage the temporal correspondence between the performance information X and the performance information Y. In the first embodiment, since the performance information X and the performance information Yt are generated from the existing music data R, it is not necessary to recognize and manage the temporal correspondence between the performance information X and the performance information Yt. Accordingly, the load required to generate the training data Z can be reduced.

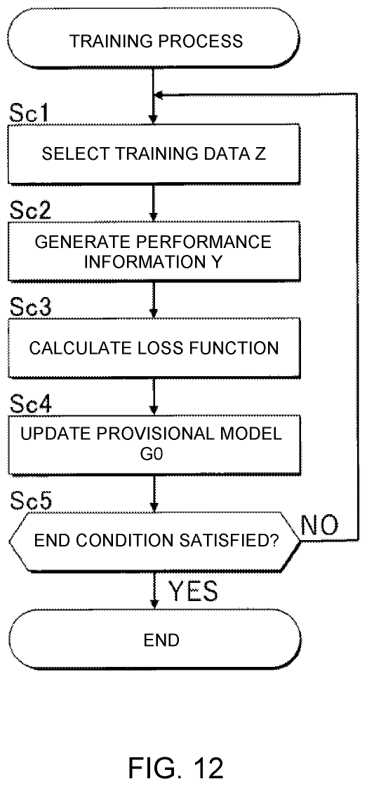

FIG. 12 is a flowchart of a process (hereinafter referred to as “training process”) by which the control device 31 (training processing unit 42) constructs a generative model G through machine learning using a plurality of pieces of training data Z. After execution of the training data generation process, the training process is started, triggered by an instruction from an administrator of the machine learning system 200, for example. The training process is one example of a method for generating a generative model G.

In response to the training process starting, the control device 31 selects any one of the plurality of pieces of training data Z (hereinafter referred to as “selected training data Z”) stored in the storage device 32 (Sc1). As shown in FIG. 10, the control device 31 generates performance information Y by processing the control data Ct of the selected training data Z using an initial or provisional generative model G (hereinafter referred to as “provisional model G0”) (Sc2). The control device 31 calculates a loss function representing the error between the performance information Y generated by the provisional model G0 and the performance information Yt of the selected training data Z (Sc3). The control device 31 updates a plurality of variables of the provisional model G0 such that the loss function is reduced (ideally, minimized) (Sc4).

The control device 31 determines whether a prescribed end condition has been met (Sc5). The end condition is, for example, the loss function falling below a prescribed threshold value, or the amount of change in the loss function falling below a prescribed threshold value. Upon determining that the end condition is not satisfied (Sc5: NO), the control device 31 selects a piece of unselected training data Z stored in the storage device 32 as the new selected training data Z (Sc1). That is, the process (Sc2 to Sc4) of updating the plurality of variables of the provisional model G0 is repeated until the end condition is satisfied (Sc5: YES).

Upon determining that the end condition is satisfied (Sc5: YES), the control device 31 ends the training process. The provisional model G0 at the time that the end condition is satisfied is set as the trained generative model G.

As can be understood from the foregoing explanation, the generative model G learns the latent relationship between the performance information Yt and the control data Ct in the plurality of pieces of training data Z. Accordingly, the trained generative model G outputs the performance information Y that is statistically appropriate for an unknown control data C under the relationship described above.

The trained generative model G is transmitted from the communication device 33 to the information processing system 100. The control device 11 of the information processing system 100 receives the generative model G via the communication device 13 and stores the generative model G in the storage device 12. The generative model G provided through the procedure described above is used for the arrangement process illustrated in FIG. 8.

### C: Third Embodiment

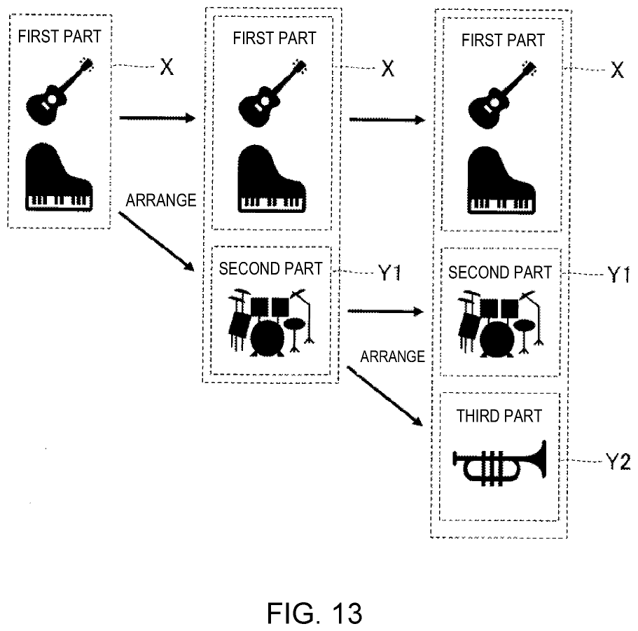

FIG. 13 is an explanatory diagram of a process carried out by the information processing system 100 according to the third embodiment. Similar to the first embodiment, the control device 11 generates the performance information Y of a second part (hereinafter referred to as “performance information Y1”) from the control data C containing the performance information X and the instrument information Q. In the third embodiment, performance information Y2 of a third part is generated from new performance information X containing the performance information X of the plurality of first parts and performance information Y1 of the second part. The third part is a performance part corresponding to a type of musical instrument different from those of the plurality of first parts and the second part, and constitutes a post-arrangement target musical piece by being played in parallel (simultaneously) with the plurality of first parts and the second part. Accordingly, the third part harmonizes musically with each of the first parts and the second part. As described above, in the third embodiment, a process of generating performance information Y from performance information X is cumulatively repeated so that the performance parts constituting the target musical piece increases sequentially.

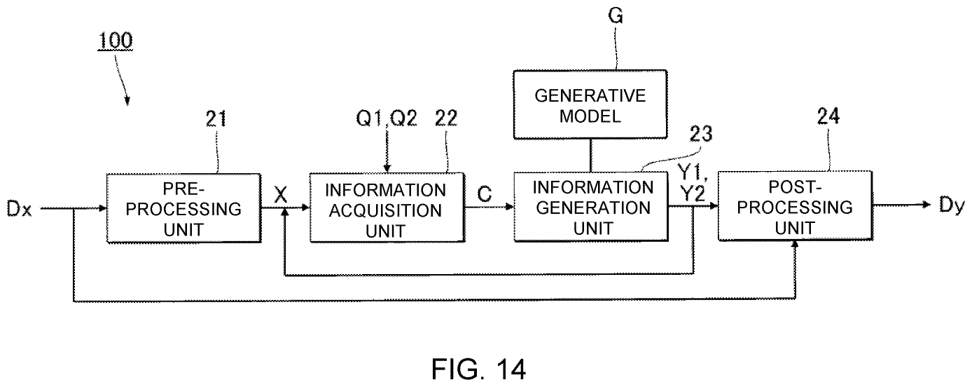

FIG. 14 is a block diagram illustrating a functional configuration of the information processing system 100 according to the third embodiment. The configuration and the operation of the pre-processing unit 21 in the third embodiment are the same as those in the first embodiment. In the third embodiment, a user operates the operation device 14 to specify the type of musical instrument corresponding to each of the second part and the third part. That is, two different types of instruments are specified by the user.

The information acquisition unit 22 first generates control data C containing performance information X representing a plurality of first parts and instrument information Q1 representing the type of musical instrument corresponding to the second part, in the same manner as in the first embodiment. The information generation unit 23 processes the control data C using the generative model G to generate performance information Y1 of the second part.

After generating the performance information Y1, the information acquisition unit 22 generates new performance information X containing the existing performance information X and the performance information Y1. That is, performance information X of the target musical piece including a plurality of first parts and a second part is generated. The information acquisition unit 22 generates control data C containing performance information X to which the second part has been added, and instrument information Q2 representing the type of musical instrument corresponding to the third part. The information generation unit 23 processes the control data C using the generative model G to generate performance information Y2 of the third part. As described above, the information generation unit 23 of the third embodiment processes the control data C containing the performance information X and the performance information Y1 using the generative model G to generate the performance information Y2 of the third part. The performance information Y2 is one example of “third performance information.”

The post-processing unit 24 generates music data Da1 of the second part from the performance information Y1 and generates music data Da2 of the third part from the performance information Y2. The post-processing unit 24 integrates the pre-arrangement music data Dx, the music data Da1 of the second part, and the music data Da2 of the third part to generate music data Dy.

The same effects as those of the first embodiment are realized in the third embodiment. In addition, in the third embodiment, the control data C, which contain the existing performance information X and the performance information Y1 that has been generated, are processed using the generative model G to generate the performance information Y2 of the third part. Accordingly, it is possible to generate performance information Y2 of the third part that is musically consistent with both the first and second parts. That is, according to the third embodiment, it is possible to arrange a target musical piece that includes a large number of performance parts. According to the third embodiment, it is possible to provide, to the user, a unique customer experience of being able to obtain new performance parts (second part and third part) that correspond to existing first parts.

The number of times that the generation of the performance information Y by the information generation unit 23 is repeated can be freely selected. In the (n+1)th processing by the information generation unit 23 (where n is a natural number), performance information Yn+1 is generated from the control data C containing, as new performance information X, performance information Yn generated in the immediately preceding nth processing and performance information X used in the nth processing.

### D: Fourth Embodiment

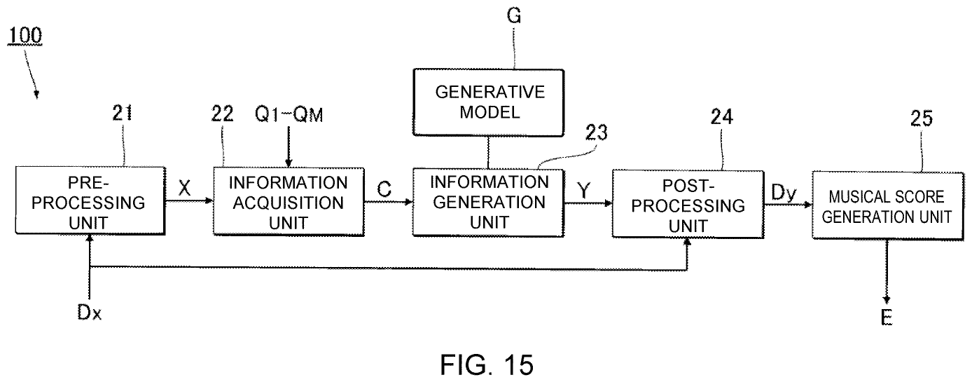

FIG. 15 is a block diagram illustrating a functional configuration of the information processing system 100 according to the fourth embodiment. The control device 11 of the fourth embodiment functions as a musical score generation unit 25, in addition to the elements that are the same as those in the first embodiment (pre-processing unit 21, information acquisition unit 22, information generation unit 23, post-processing unit 24).

The musical score generation unit 25 generates musical score data E from music data Dy. The musical score data E are data representing the musical score of an edited target musical piece that have been edited and contains first and second parts. Examples of musical score data E include data in MusicXML format or PDF format. Any known technique can be employed for the generation of the musical score data E. The musical score generation unit 25 displays, on a display device (display, not shown), the musical score represented by the musical score data E.

The same effects as those of the first embodiment are realized in the fourth embodiment. In addition, in the fourth embodiment, since the musical score data E of the edited target musical piece, containing first and second parts, are generated, the user can confirm the content of the musical score of the post-arrangement target musical piece.

It is also possible to apply the configuration of the third embodiment to the fourth embodiment. That is, the target musical piece represented by the musical score data E can contain a third part (and even other parts) in addition to the first and second parts.

### E: Modified Example

Specific modified embodiments to be added to each of the embodiments exemplified above are illustrated below. Two or more embodiments arbitrarily selected from the following examples can be appropriately combined insofar as they are not mutually contradictory.
(1) In each of the embodiments described above, an example is shown in which the control data C contain the performance information X and the instrument information Q, but the control data C can contain other information. For example, the control data C can contain condition information that specifies musical conditions relating to the second part. The condition information specifies conditions such as whether the constituent notes of the second part are single notes or chords, and whether to generate the second part for all sections or only for some sections of the target musical piece. In addition, the condition information can contain the difficulty level of the performance of the second part. According to the configuration described above, it is possible to generate a variety of target musical pieces that satisfy conditions specified by the condition information.
(2) In each of the above-mentioned embodiments, any section of the target musical piece can be the unit of processing by the information processing system 100. For example, the above-mentioned arrangement process can be executed, sequentially or in parallel, for each of a plurality of sections (hereinafter referred to as “unit sections”) obtained by dividing a target musical piece on a time axis. The music data Dx and the music data Dy represent note sequences corresponding to one unit section within the target musical piece. Each unit section is a section of a length of time corresponding to a prescribed number of bars (for example, four bars to eight bars) in the target musical piece. Music data Da of the second part for all sections of the target musical piece can be generated through a single arrangement process targeting all sections of the target musical piece.
(3) In each of the above-mentioned embodiments, the music data Da of the second part are integrated with the music data Dx of the first parts to generate the music data Dy, but the generation of the music data Dy can be omitted. For example, the music data Da of the second part can be generated as the final result (music data Dy). That is, the music data Dy are expressed as data representing a time series of notes constituting the second part. The music data Dy can contain parts other than the second part (for example, the first or third part), or can contain only the second part.

Note that the musical score represented by the musical score data E in the fourth embodiment can be a musical score containing the first and second parts (and other parts such as the third part), a musical score containing only the second part, or a musical score containing the second part and the third part (that is, new parts).
(4) In each of the above-mentioned embodiments, an example is shown in which the music data Da corresponding to the performance information Y are integrated with the existing music data Dx, but the method of generating the post-arrangement music data Dy is not limited to the example described above. For example, the post-processing unit 24 can integrate the performance information X with the performance information Y and generate the music data Dy from the performance information after integration.
(5) In each of the above-mentioned embodiments, an example is shown in which the performance information X represents a plurality of first parts, but the number of first parts represented by the performance information X (music data Dx) can be one. The performance information X is comprehensively expressed as data representing first parts corresponding to one or more instruments.

In addition, in each of the above-mentioned embodiments, an example is shown in which the performance information Y represents a single second part, but the number of second parts represented by the performance information Y (music data Da) can be two or more. The performance information Y is comprehensively expressed as data representing second parts corresponding to one or more instruments.
(6) In each of the above-mentioned embodiments, the control data C containing the instrument information Q are processed using a single generative model G to generate performance information Y of the musical instrument corresponding to the instrument information Q, but a plurality of generative models G corresponding to different musical instruments can be selectively used for the generation of the performance information Y.

For example, of a plurality of pieces of training data Z generated by a training data generation process, a plurality of pieces of training data Z in which performance parts of a specific musical instrument are selected as the second part can be applied to the training process to construct a generative model G corresponding to the musical instrument. The generative model G of each musical instrument generates performance information Y of the performance part corresponding to the musical instrument.

The information generation unit 23 generates the performance information Y of the musical instrument by processing the control data C using, from among the plurality of generative models G corresponding to different musical instruments, the generative model G corresponding to the musical instrument selected by the user. In the configuration described above, the configuration of inputting instrument information Q into the generative model G is omitted. That is, it is not necessary for the control data C to contain the instrument information Q.

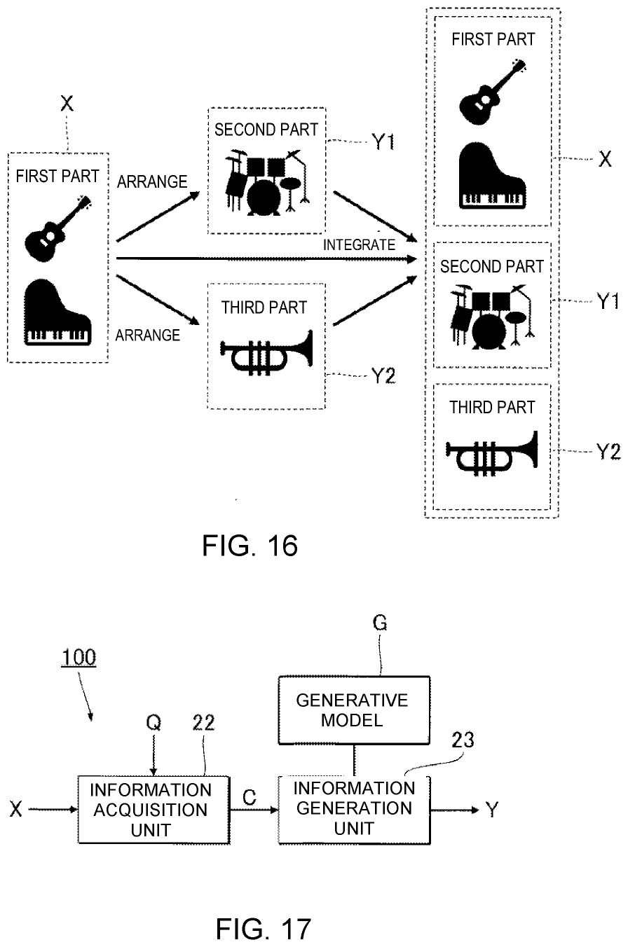

According to each of the above-mentioned configurations in which the instrument information Q is input to the generative model G, a single generative model G can be used to generate the performance information Y of a variety of musical instruments. That is, there is the advantage that it is not necessary to prepare a separate generative model G for each musical instrument.
(7) In the third embodiment, the process of generating the performance information Y from the performance information X is cumulatively repeated to generate the second and third parts of the target musical piece, but the method of generating a target musical piece containing the second and third parts is not limited to the example described above. For example, as illustrated in FIG. 16, the control device 11 can execute, in sequence or in parallel, a process of generating performance information Y1 of the second part from performance information X and a process of generating performance information Y2 of the third part from the performance information X, and integrate the performance information X (music data Dx), the performance information Y1 (music data Da1), and the performance information Y2 (music data Da2) to generate the target musical piece.
(8) In each of the above-mentioned embodiments, a transformer is illustrated as an example of the generative model G, but the configuration or the type of generative model G can be freely selected. For example, deep neural networks such as a recurrent neural network (RNN) or long short-term memory (LSTM) can be used as the generative model M. The generative model G can include a combination of a plurality of types of statistical models.
(9) In each of the above-mentioned embodiments, the information processing system 100 and the machine learning system 200 are illustrated as separate systems, but the functions of the machine learning system 200 (training data generation unit 41 and training processing unit 42) can be incorporated into the information processing system 100.
(10) In each of the above-mentioned embodiments, an example is shown in which each performance part of the target musical piece corresponds to a musical instrument, but some or all of the plurality of performance parts constituting a target musical piece can be vocal parts corresponding to vocal sounds. That is, the “musical instrument” in each of the above-mentioned embodiments can be replaced with “singer”. In addition, the “musical instrument” in each of the above-mentioned embodiments can be replaced with “sound source,” which includes both instruments and singers. That is, each of the performance parts of a target musical piece corresponds to a different type of sound source.
(11) For example, it is possible to realize the information processing system 100 with a server device that communicates with terminal devices, such as smartphones, tablet terminals, and personal computers. For example, the control device 11 receives, via the communication device 13, the instrument information Q and the music data Dx transmitted from a terminal device, and uses the music data Dx and the instrument information Q to generate music data Dy. The control device 11 transmits the music data Dy to the terminal device via the communication device 13.

In an embodiment in which the pre-processing unit 21, which generates the performance information X from the music data Dx, is installed in the terminal device, the pre-processing unit 21 is omitted from the information processing system 100, as shown in FIG. 17. That is, the information acquisition unit 22 receives, via the communication device 13, the instrument information Q and the performance information X transmitted from the terminal device, and generates the control data C containing the performance information X and the instrument information Q.

In addition, in an embodiment in which the post-processing unit 24, which generates the music data Da from the performance information Y, is installed in the terminal device, the post-processing unit 24 is omitted from the information processing system 100, as shown in FIG. 17. That is, the information generation unit 23 transmits the performance information Y generated by the generative model G from the communication device 13 to the terminal device. The terminal device generates the music data Da (and also music data Dy) from the performance information Y received from the information processing system 100.
(12) As described above, the functions of the information processing system 100 exemplified above are realized by cooperation between one or more processors that constitute the control device 11, and a program stored in the storage device 12. The program according to the present disclosure can be provided in a form stored in a computer-readable storage medium and installed on a computer. The storage medium is, for example, a non-transitory storage medium, a good example of which is an optical storage medium (optical disc) such as a CD-ROM, but can include storage media of any known form, such as a semiconductor storage medium or a magnetic storage medium. Non-transitory storage media include any storage medium that excludes transitory propagating signals and does not exclude volatile storage media. In addition, in a configuration in which a distribution device distributes programs via a communication network, a storage medium that stores the program in the distribution device corresponds to the non-transitory storage medium.

### F: Additional Statement

For example, the following configurations can be understood from the embodiments exemplified above.

An information processing method according to one aspect (aspect 1) of the present disclosure comprises: acquiring first performance information representing a first part corresponding to one or more instruments in a musical piece; and processing control data containing the first performance information using a generative model trained through machine learning, thereby generating second performance information representing a second part corresponding to a musical instrument different from the one or more instruments in the musical piece. According to the aspect described above, second performance information of a second part is generated from first performance information representing an existing first part of a musical piece, the second part corresponding to a musical instrument different from the musical instrument of the first part. Accordingly, it is possible to reduce the burden on a user that produces a second part of a musical piece other than the existing first parts.

“First/second performance information” is data in any format representing parts that constitute a musical piece. For example, performance information is data representing a time series of notes corresponding to a specific part. For example, performance information includes a time series of a plurality of tokens representing a specific part of a musical piece. Each token specifies conditions (for example, pitch, position, and duration) for pronouncing each note constituting a musical piece, for example.

A “generative model” is a statistical model of any configuration that has learned, through machine learning, the relationship between control data and second performance information. For example, a generative model is trained in advance through machine learning using training data containing control data for learning, and second performance information. That is, the trained generative model generates second performance information that is statistically appropriate with respect to unknown control data, under a latent relationship between second performance information and control data in a plurality of pieces of training data.

In a specific example (aspect 2) of aspect 1, the control data contain instrument information that specifies the type of musical instrument corresponding to the second part. According to the aspect described above, it is possible to generate second performance information for a part corresponding to a type of musical instrument specified by the instrument information. Accordingly, for example, in a configuration in which the instrument information specifies the type of musical instrument selected by the user, it is possible to generate a second part that aligns with the user's intentions or preferences. In addition, by changing the type of musical instrument specified by the instrument information, it is possible to generate second parts of a variety of instruments using a single generative model.

In a specific example (aspect 3) of aspect 1 or 2, after the second performance information is generated, the control data containing the first performance information and the second performance information are processed by the generative model, thereby generating third performance information representing a third part corresponding to a musical instrument different from the musical instruments corresponding to the first part and the second part. According to the aspect described above, after generation of the second performance data, the control data containing the first performance information and the second performance information are processed using the generative model to generate the third performance information of the third part. Accordingly, it is possible to generate the third performance information of the third part that is musically consistent with both the first and second parts.

In a specific example (aspect 4) of any one of aspects 1 to 3, the first performance information is a time series of tokens representing the first part, and the second performance information is a time series of tokens representing the second part. According to the aspect described above, the first performance information, which is a time series of tokens representing the first part, is processed by the generative model, thereby generating the second performance information, which is a time series of tokens representing the second part. Accordingly, it is possible to use a generative model that is suitable for the processing of a time series of a plurality of tokens to generate an effective second part that is musically consistent with the first part.

In a specific example (aspect 5) of aspect 4, the first performance information is further generated from first music data representing a time series of notes constituting the first part, and second music data representing a time series of notes constituting the second part are generated from the second performance information. In the aspect described above, first performance information is generated from first music data representing a time series of notes constituting the first part. Accordingly, existing music data can be used to generate the second performance information. In addition, second performance information is generated from second music data representing a time series of notes constituting the second part. Accordingly, musical sounds of the second part can be generated using existing sound sources that generate musical sounds in accordance with music data.

“(First/second) music data” are, for example, MIDI format data that specify the pitch and pronunciation period for each note constituting the musical piece. The (first / second) performance information can also be expressed as intermediate or alternative data in a format different from that of music data.

In a specific example (aspect 6) of aspect 5, the second music data are data representing a time series of notes constituting the first part and the second part, and musical score data representing a musical score of a musical piece containing the first part and the second part are further generated from the second music data. According to the aspect described above, a musical score can be effectively used for an edited musical piece containing first and second parts. Specifically, musical score data are used to display musical scores or for automatic performances of musical pieces.

An information processing system according to one aspect (aspect 7) of the present disclosure comprises: an information acquisition unit for acquiring first performance information representing a first part corresponding to one or more instruments in a musical piece; and an information generation unit for processing control data containing the first performance information using a generative model trained through machine learning, thereby generating second performance information representing a second part corresponding to a musical instrument different from the one or more instruments in the musical piece.

A program according to one aspect (aspect 8) of the present disclosure causes a computer system to function as: an information acquisition unit for acquiring first performance information representing a first part corresponding to one or more instruments in a musical piece; and an information generation unit for processing control data containing the first performance information using a generative model trained through machine learning, thereby generating second performance information representing a second part corresponding to a musical instrument different from the one or more instruments in the musical piece.

What is claimed is:

1. An information processing method realized by a computer system, the method comprising:
acquiring first performance information representing a first part corresponding to one or more musical instruments in a musical piece; and
generating second performance information representing a second part corresponding to a musical instrument different from the one or more musical instruments in the musical piece, by processing control data containing the first performance information using a generative model trained through machine learning.

2. The information processing method according to claim 1, wherein
the control data contain instrument information that specifies a type of the musical instrument corresponding to the second part.

3. The information processing method according to claim 1, further comprising
after the generating of the second performance information, by processing the control data containing the first performance information and the second performance information by the generative model, generating third performance information representing a third part corresponding to a musical instrument different from the one or more musical instruments corresponding to the first part and the musical instrument corresponding to the second part.

4. The information processing method according to claim 1, wherein
the first performance information is a time series of tokens representing the first part, and
the second performance information is a time series of tokens representing the second part.

5. The information processing method according to claim 4, further comprising
generating the first performance information from first music data representing a time series of notes constituting the first part, and
generating second music data representing a time series of notes constituting the second part from the second performance information.

6. The information processing method according to claim 5, wherein
the second music data represent a time series of notes constituting the first part and the second part, and
the method further comprises
generating, from the second music data, musical score data representing a musical score of the musical piece containing the first part and the second part.

7. An information processing system comprising:
an electronic controller including at least one processor, the electronic controller being configured to
acquire first performance information representing a first part corresponding to one or more musical instruments in a musical piece, and
generate second performance information representing a second part corresponding to a musical instrument different from the one or more musical instruments in the musical piece, by processing control data containing the first performance information using a generative model trained through machine learning.

8. The information processing system according to claim 7, wherein
the control data contain instrument information that specifies a type of the musical instrument corresponding to the second part.

9. The information processing system according to claim 7, wherein
after generating the second performance information, by processing the control data containing the first performance information and the second performance information by the generative model, the electronic controller is configured to generate third performance information representing a third part corresponding to a musical instrument different from the one or more musical instruments corresponding to the first part and the musical instrument corresponding to the second part.

10. The information processing system according to claim 7, wherein
the first performance information is a time series of tokens representing the first part, and
the second performance information is a time series of tokens representing the second part.

11. The information processing system according to claim 10, wherein
the electronic controller is further configured to
generate the first performance information from first music data representing a time series of notes constituting the first part, and
generate second music data representing a time series of notes constituting the second part from the second performance information.

12. The information processing system according to claim 11, wherein
the second music data represent a time series of notes constituting the first part and the second part, and
the electronic controller is further configured to generate, from the second music data, musical score data representing a musical score of the musical piece containing the first part and the second part.

13. A non-transitory computer-readable medium storing a program that causes a computer system to execute a process, the process comprising:
acquiring first performance information representing a first part corresponding to one or more musical instruments in a musical piece, and
generating second performance information representing a second part corresponding to a musical instrument different from the one or more musical instruments in the musical piece, by processing control data containing the first performance information using a generative model trained through machine learning.
